(19) United States
(12) Patent Application Publication
(10) Pub. No.: US 2020/0028134 A1
(43) Pub. Date: Jan. 23, 2020

(54) BATTERY CELL FOR AN ELECTRIC VEHICLE BATTERY PACK

(71) Applicant: SF Motors, Inc., Santa Clara, CA (US)

(72) Inventors: Scott Quinlan Freeman Monismith, Santa Clara, CA (US); Jeremy Andrew Elsberry, Santa Clara, CA (US); Ying Liu, Santa Clara, CA (US); Yifan Tang, Santa Clara, CA (US)

(21) Appl. No.: 16/039,093

(22) Filed: Jul. 18, 2018

(51) Int. Cl. H01M 2/10; H01M 10/058; H01M 10/658; H01M 2/02; H01M 2/08

(52) U.S. Cl. CPC H01M 2/1083; H01M 10/058; H01M 10/658; H01M 2/0287; H01M 2/0285; H01M 2/08; H01M 2/0277

(57) ABSTRACT

This disclosure provides a battery cell for an electric vehicle battery pack. The battery cell can include a housing containing an electrolyte material, a first polarity terminal disposed at a lateral end of the battery cell, and a buckling plate disposed at the lateral end of the battery cell. The buckling plate can include a planar portion and a domed portion. The domed portion can deflect the electrolyte material in response to a first predetermined threshold pressure within the battery cell. The battery cell can include a melting component including an inner ring electrically coupled to a perimeter of the domed portion of the buckling plate, and an outer ring electrically coupled to the electrolyte material. A plurality of spokes can couple the inner ring with the outer ring and can melt in response to either a predetermined threshold temperature or a predetermined threshold current.

### CROSS-REFERENCE TO RELATED APPLICATIONS

The present application claims priority under 35 U.S.C. § 119 U.S. Provisional Patent Application 62/646,982, filed Mar. 23, 2018 and titled “BATTERY CELL FOR AN ELECTRIC VEHICLE BATTERY PACK,” which is incorporated herein by reference in its entirety.

### BACKGROUND

Electric vehicles such as automobiles can include on-board battery cells or battery packs to power the electric vehicles. Batteries can experience a condition such as thermal runaway under some operating conditions or environmental conditions.

### SUMMARY

At least one aspect of this disclosure is directed to a battery cell of a battery pack to power an electric vehicle. The battery cell can include a housing containing an electrolyte material. The battery cell can include a first polarity terminal disposed at a lateral end of the battery cell. The battery cell can include a buckling plate disposed at the lateral end of the battery cell and electrically connected to the first polarity terminal. The buckling plate can include a planar portion and a domed portion. The domed portion can have a convex part extending toward the electrolyte material. The domed portion can deflect away from the electrolyte material in response to a first predetermined threshold pressure within the battery cell. The battery cell can include a melting component including an inner ring surrounding and electrically coupled to a perimeter of the domed portion of the buckling plate. The melting component can include an outer ring surrounding the inner ring and electrically coupled to the electrolyte material. The battery cell can also include a plurality of spokes coupling the inner ring with the outer ring. The plurality of spokes can melt in response to either a predetermined threshold temperature or a predetermined threshold current within the battery cell.

At least one aspect of this disclosure is directed to a method. The method can include providing a battery cell of a battery pack to power an electric vehicle. The battery cell can include a housing containing an electrolyte material, and a first polarity terminal disposed at a lateral end of the battery cell. The battery cell can include a buckling plate disposed at the lateral end of the battery cell and electrically connected with the first polarity terminal. The buckling plate can include a planar portion and a domed portion. The domed portion can have a convex part extending toward the electrolyte material. The domed portion can be structured to deflect away from the electrolyte material in response to a first predetermined threshold pressure within the battery cell. The battery cell can include a melting component. The melting component can have an inner ring surrounding and electrically coupled with a perimeter of the domed portion of the buckling plate, an outer ring surrounding the inner ring and electrically coupled with the electrolyte material, and a plurality of spokes coupling the inner ring with the outer ring. The plurality of spokes can melt in response to at least one of a predetermined threshold temperature and a predetermined threshold current within the battery cell.

At least one aspect of this disclosure is directed to a method of providing battery cells for battery packs of electric vehicles. The method can include forming a housing for a battery cell of a battery pack having a plurality of battery cells. The housing can have a body region and a head region disposed at a lateral end of the battery cell. The method can include housing, within the body region of the battery cell, an electrolyte material. The method can include disposing, at the head region of the housing, a first polarity terminal. The method can include disposing, at the head region of the housing, a buckling plate having a planar portion and a domed portion. The domed portion can have a convex part extending away from the lateral end of the battery cell. The domed portion can deflect toward the lateral end of the battery cell in response to a first predetermined threshold pressure within the battery cell. The method can include disposing, at the head region of the housing, a melting component to electrically couple an inner ring of the melting component to the domed portion of the buckling plate and to electrically couple an outer ring of the melting component to the electrolyte material. The melting component can have a plurality of spokes coupling the inner ring with the outer ring. The plurality of spokes can melt in response to either a predetermined threshold temperature or a predetermined threshold current within the battery cell. The method can include crimping a perimeter edge of the buckling plate around the first polarity terminal to electrically couple the buckling plate to the first polarity terminal.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts an example battery cell for an electric vehicle battery pack, according to an illustrative implementation;

FIG. 2 depicts an example buckling plate that can be used with a battery cell of an electric vehicle battery pack, according to an illustrative implementation;

FIG. 3 depicts an example ring or wagon wheel that can be used with a battery cell of an electric vehicle battery pack, according to an illustrative implementation;

FIG. 4 depicts an example perspective view of a buckling plate and wagon wheel arranged together, according to an illustrative implementation;

FIG. 5 depicts a cross-sectional view of an example buckling plate and wagon wheel arranged together, according to an illustrative implementation;

FIG. 6 depicts a cross-sectional view of a portion of a first example battery cell for an electric vehicle battery pack including a buckling plate and a wagon wheel;

FIG. 7 depicts a cross-sectional view of a portion of a second example battery cell for an electric vehicle battery pack including a buckling plate and a wagon wheel;

FIG. 8 is a block diagram depicting a cross-sectional view of an example battery pack for holding battery cells in an electric vehicle, according to an illustrative implementation;

FIG. 9 is a block diagram depicting a top-down view of an example battery pack for holding for battery cells in an electric vehicle, according to an illustrative implementation;

FIG. 10 is a block diagram depicting a cross-sectional view of an example electric vehicle installed with a battery pack, according to an illustrative implementation;

FIG. 11 depicts a flow chart of an example process undergone by a battery experiencing various conditions associated with thermal runaway, according to an illustrative implementation; and

FIG. 12 depicts a flow chart of an example process of providing a battery cell for a battery pack of an electric vehicle, according to an illustrative implementation; and

FIG. 13 depicts a flow chart of an example process of providing a battery cell for a battery pack of an electric vehicle, according to an illustrative implementation.

Following below are more detailed descriptions of various concepts related to, and implementations of battery cells for battery packs of electric vehicles, and methods, apparatuses, and systems to improve the performance of the battery cells. The various concepts introduced above and discussed in greater detail below may be implemented in any of numerous ways, as the described concepts are not limited to any particular manner of implementation.

### DETAILED DESCRIPTION

Systems and methods described herein relate to improving the performance of battery cells for battery packs that can provide power to electric vehicles (“EVs”). Battery packs, which can be referred to herein as battery modules, can include lithium ion battery cells. Lithium ion batteries perform well under normal operating conditions. However, certain abuse or out of tolerance range conditions can lead to the failure of lithium ion batteries. For example, when a battery cell is abused thermally, electrically, or mechanically, the battery cell has the potential to undergo a condition known as thermal runaway. During thermal runaway, reactions occurring on the surface of a negative electrode, also referred to as an anode, of the battery can cause heat generation, which in turn can accelerate the rate of the reaction, thereby creating a feedback loop that can result in rapid temperature acceleration of the battery. In some instances, this feedback loop can cause a battery cell failure.

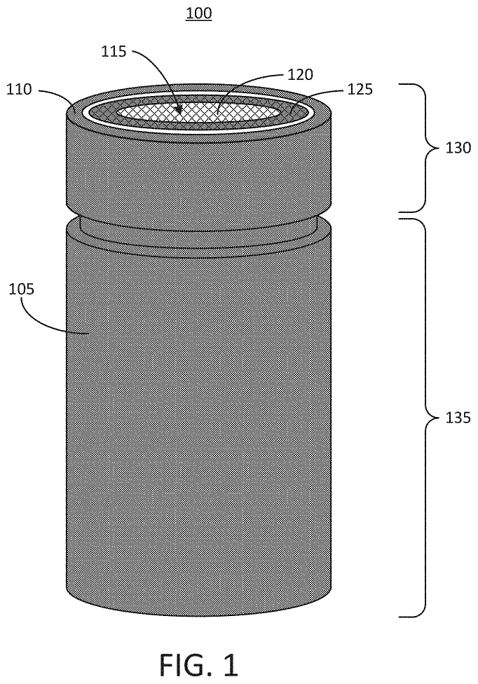

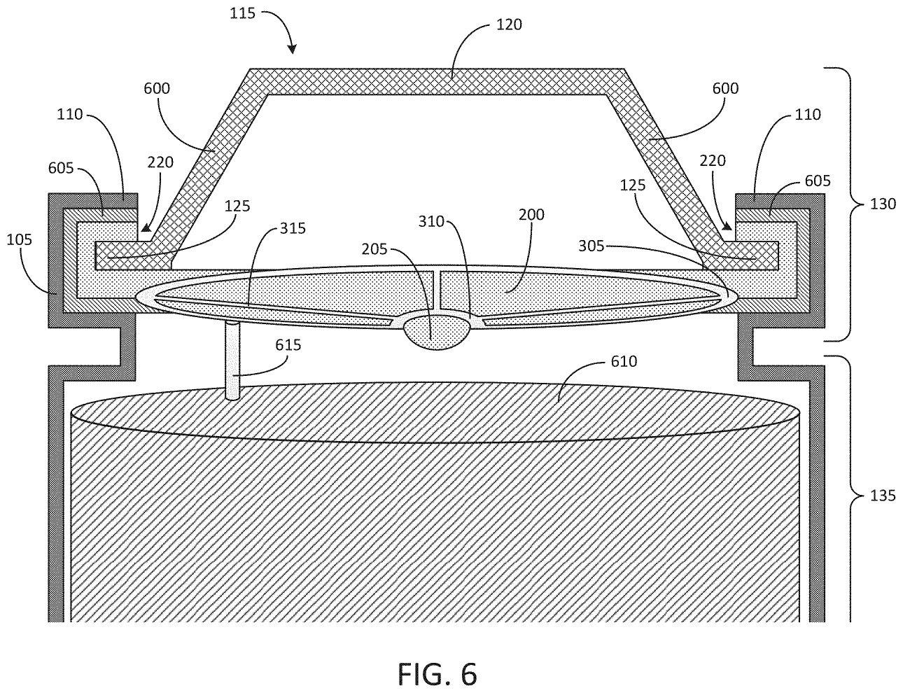

FIG. 1 depicts an example battery cell 100 for an electric vehicle battery pack. The battery cell 100 includes a housing 105. The housing includes a head portion 130 and a body portion 135. The head portion 130 is positioned at a lateral end of the battery cell 100 that is opposite the body portion 135. The body portion of the housing 105 can contain an electrolyte material or “jelly roll” that provides electric power. The electrolyte material is shown and described in connection with FIG. 6, for example. The housing 105 can be electrically insulated from a positively charged portion of the electrolyte material and can be electrically coupled to a negatively charged portion of the electrolyte material to allow the housing 105 to serve as a negative terminal of the battery cell 100. For example, the housing 105 can be formed from a conductive metal, such as steel. The top perimeter edge of the housing 105 includes a lip 110, which can serve as the negative terminal and can be electrically coupled to a negative portion of the electrolyte material contained within the housing 105. Another portion of the upper surface of the battery cell 100 can serve as a positive terminal 115. The positive terminal 115 includes an upper surface 120 and a lower surface 125. The upper surface 120 (which can be referred to herein as a “table top”) of the positive terminal 115 can be positioned at a height above the height of the lip 110 (e.g., by 1-3 millimeters). The lower surface 125 of the positive terminal 115 can be recessed into the housing 105. For example, the lower surface 125 of the positive terminal 115 can be positioned at a height 1-3 millimeters below the height of the lip 110.

Thermal runaway in the battery cell 100 can be heralded by an increase in any combination of gas pressure, temperature, or electric current in the region beneath the positive terminal 115 of the battery cell 100, which can be referred to herein as a cap. Built-in caps for battery cells such as the battery cell 100 can include a current interrupt device (CID) and one or more vents to release gas pressure buildup within the battery cell 100. For example, the CID can respond to an internal pressure by buckling away from the electrolyte material housed within the housing 105 when the pressure reaches or exceeds an activation threshold, thereby disconnecting or otherwise interrupting the flow or electric current. When pressure builds up beyond the activation threshold of the CID, the vents can rupture, allowing gas to escape, thereby relieving the pressure. However, while such a CID can respond to pressure increases that may indicate that thermal runaway is imminent, the CID does not directly respond to electrical and temperature increases that can also signal the onset of thermal runaway. The battery cell 100 at its various components described herein provides solutions that can respond to both of these stimuli (as well as to excessive gas pressure) to mitigate consequences of out-of-tolerance range thermal events in the battery cell 100. For example, the battery cell 100 described herein can incorporate at least two components which, in concert with one another, can respond to pressure, temperature, and current at pre-determined appropriate levels to interrupt the flow of current within the battery cell 100 when any one of those pre-determined levels is reached. The levels for each of these stimuli can be selected based on levels that may indicate the onset of thermal runaway.

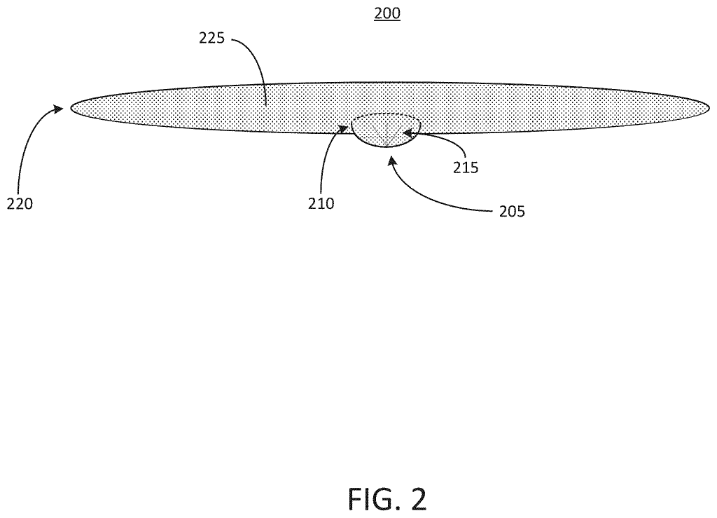

FIG. 2 depicts an example buckling plate 200 that can be used with a battery cell of an electric vehicle battery pack, such as the battery cell 100 shown in FIG. 1. The buckling plate 200 is shown in a perspective view in FIG. 2. The buckling plate 200 can respond to a high pressure stimulus that may indicate thermal runaway by allowing the high-pressure gas to escape from the inside of the housing 105, thereby reducing the pressure. The buckling plate 200 can have a shape that matches, dovetails with, or is similar to the cross-sectional shape of the housing 105. For example, in instances in which the housing 105 is cylindrical with circular cross sections, the buckling plate 200 can be circular. The buckling plate 200 may also have a different shape. For example, the buckling plate 200 can be elliptical, oval, square, hexagonal, octagonal, or other suitable shape. The buckling plate 200 can include a planar portion 225, which can form a majority of the surface of the buckling plate 200. The buckling plate 200 can also include at least one domed portion 205 that can extend outward away from the plane of the planar portion 225 of the buckling plate 200. Thus, the buckling plate 200 can include a flat disc of material forming the planar portion 225, as well as the domed portion 205 that extends away from the planar portion 225. The buckling plate 200 can include a perimeter edge 220, and the domed portion 205 includes a perimeter edge 210. The planar portion 225 can include the portion of the buckling plate that extends between the perimeter edge 220 of the buckling plate 200 and the perimeter edge 210 of the domed portion 205. The domed portion 205 meets the planar portion 225 at the perimeter edge 210 of the domed portion 205.

The domed portion 205 of the buckling plate 200 can include a convex surface that can face downwards (e.g., into the housing 105) toward the electrolyte material. The surface of the domed portion 205 can have a form or shape of a portion of a sphere. The domed portion 205 can also have a curved non-spherical shape. The domed portion 205 can be positioned in the center of the buckling plate 200. For example, the buckling plate 200 and the domed portion 205 can be concentric with one another. The domed portion 205 can also be offset from a center of the buckling plate 200. The planar portion 225 and the domed portion 205 can be formed integrally with one another. For example, the buckling plate 200 can initially be formed into a flat surface, and a portion of the surface can be pressed away from the plane of the flat surface to form the domed portion 205. The remainder of the flat surface can serve as the planar portion 225. As a result, the domed portion 205 can be hollow, and may have the same thickness as the planar portion 225 of the buckling plate 200. The thickness of the domed portion 205 of the buckling plate 200 and the thickness of the planar portion 225 of the buckling plate 200 can be in the range of 0.5 millimeters to 0.7 millimeters. Other ranges both greater than or less than this range are possible.

Under normal operating conditions, the buckling plate 200 can form part of a seal that separates the electrolyte material within the housing 105 from the external environment. When the pressure inside the battery cell 100 reaches a threshold value (e.g., a value that may be indicative of thermal runaway), the domed portion 205 can buckle upwards (e.g., away from the electrolyte material). The threshold pressure that causes the domed portion 205 of the buckling plate 200 to buckle away from the electrolyte material can be in the range of 60 pounds per square inch (PSI) to 500 PSI. The domed portion 205 of the buckling plate 200 can also rupture. For example, when pressure increases to a second threshold value, which may be equal to or greater than the threshold value at which the domed portion 205 of the buckling plate 200 buckles, the domed portion 200 may become torn or ruptured. The second threshold pressure can be in the range of 60 PSI to 500 PSI. In this example, gas generated during thermal runaway that caused the high pressure condition can escape through the ruptured buckling plate 200.

The buckling plate 200 can be designed to rupture more easily in the area of the domed portion 205 as compared to the planar portion 225. For example, the domed portion 205 can include one or more scoring lines 215 (which may also be referred to as scoring marks) configured to intentionally weaken at least a portion of the material of the buckling plate 200 in the region of the domed portion 205, to facilitate rupturing of the buckling plate 200 in the event that pressure within the battery cell 100 reaches the second threshold value above the threshold value at which the domed portion 205 buckles. The domed portion 205 can tear along seams defined by the scoring lines 215, causing stresses to develop in the walls of the domed portion 205 and ripping the surface of the domed portion 205 along the scoring lines 215. The scoring lines 215 can be arranged in a circular pattern, a star-shaped pattern, a hatched pattern, a symmetrical or asymmetrical pattern, or any other pattern configured to facilitate rupturing of the domed portion 205 in response to a second predetermined pressure threshold. The scoring lines 215 can be arranged to radiate outward from the center of the domed portion 205. The domed portion 205 can also include other features selected to facilitate rupturing of the domed portion 205 under high pressure conditions. For example, the domed portion 205 can be formed from a material having a lower strength than a material selected for the majority of the buckling plate 200.

The buckling plate 200 can be formed from a rigid material, such as a metal or a rigid polymer. The buckling plate 200 can be used to carry electrical current. As a result, the buckling plate 200 can be formed from an electrically conductive material, such as copper or steel. The buckling plate 200 can have a diameter in the range of 19 millimeters to 23 millimeters. For example, the buckling plate 200 can have a diameter of 21 millimeters measured between opposite sides of the perimeter edge 220. The domed portion 205 of the buckling plate 200 can have a diameter in the range of 5 millimeters to 9 millimeters. For example, the domed portion 205 of the buckling plate 200 can have a diameter of 7 millimeters measured between opposite sides of the perimeter edge 210 of the domed portion 205. As described above, the thickness of the buckling plate 200 can be in the range of 0.5 millimeters to 0.7 millimeters, and may be uniform or substantially uniform across both the planar portion 225 and the domed portion 205.

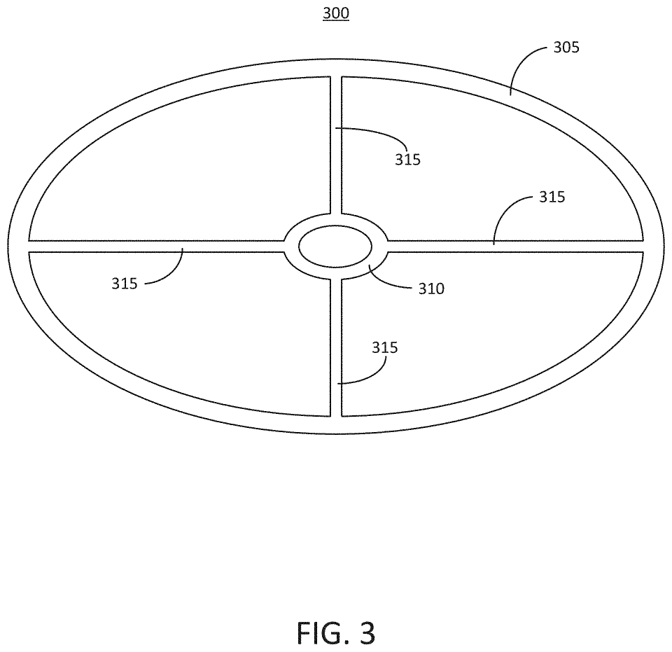

FIG. 3 depicts an example wire ring 300, which can also be referred to herein as a melting component 300 or wagon wheel 300, that can be used with a battery cell of an electric vehicle battery pack, such as the battery cell 100 of FIG. 1. The wagon wheel 300 can also be used in conjunction with the buckling plate 200, as described further below. The wagon wheel 300 can be or can include a melting component that can respond to a temperature threshold or a current threshold within the battery cell 100. The wagon wheel 300 can include an outer ring 305 and an inner ring 310. The outer ring 305 can be coupled with the inner ring 310 by spokes 315 extending radially outward from the inner ring 310 to the outer ring 305. Both the outer ring 305 and the inner ring 310 can have a shape selected to match a cross sectional shape of the housing 105 of the battery cell 100. For example, in instances in which the housing 105 is cylindrical with circular cross sections, the outer ring 305 and the inner ring 310 of the wagon wheel 300 can be generally circular. The wagon wheel 300 may also have a different shape in some other instances. For example, the wagon wheel 300 can be elliptical, oval, square, hexagonal, octagonal, or any other suitable shape. The outer ring 305 can be concentric with the inner ring 310. The spokes 315 can be arranged in a radially symmetric fashion about the center of the wagon wheel 300, as shown in FIG. 3. While four spokes 315 are shown in the wagon wheel 300 depicted in FIG. 3, this configuration is only one example. The wagon wheel 300 can include more or fewer spokes 315 than are shown in FIG. 3. For example, the wagon wheel 300 may include 2, 3, 5, 6, 7, 8 or any other number of spokes 315.

The wagon wheel 300 can be formed from a material selected to degrade, decompose, or melt at a threshold temperature to facilitate melting of at least a portion of the wagon wheel 300 in the event that the threshold temperature (e.g., a temperature that may indicate thermal runaway) is reached within the battery cell 100. Such a material can be referred to herein as a low melting point material, and therefore the wagon wheel 300 can be referred to herein as a low melting point component, or simply a melting component. A threshold temperature associated with thermal runaway may be in the range of about 120 degrees C. to about 140 degrees C. For example, a threshold temperature may be around 130 degrees C. The wagon wheel 300 can be formed from a low melting point metal or alloy selected for its ability to melt at the predetermined threshold temperature. Because the wagon wheel 300 can carry electrical current under normal operating conditions, the wagon wheel 300 can be formed from materials that are also electrically conductive, in addition to having a melting point at or near the threshold temperature. For example, the wagon wheel 300 can be or can include materials such as bismuth or lead, or alloys that include those materials.

The wagon wheel 300 can be subjected to heat approaching or exceeding its melting point in a variety of ways. For example, the air (or other gas) temperature in the battery cell may rapidly increase and exceed the melting point of the wagon wheel 300 as a result of a thermal runaway event experienced by the battery cell 100. In addition, a spike in the current passing through the wagon wheel 300 may heat the wagon wheel 300 to its melting point via resistive heating. Thus, melting of the wagon wheel 300 can occur as a result of either temperature or current increases in the battery 110. The wagon wheel 300 can be used along with the buckling plate 200 to interrupt current and release pressure in response to predetermined levels of temperature, pressure, or current being experienced within the battery cell 100, as described further below.

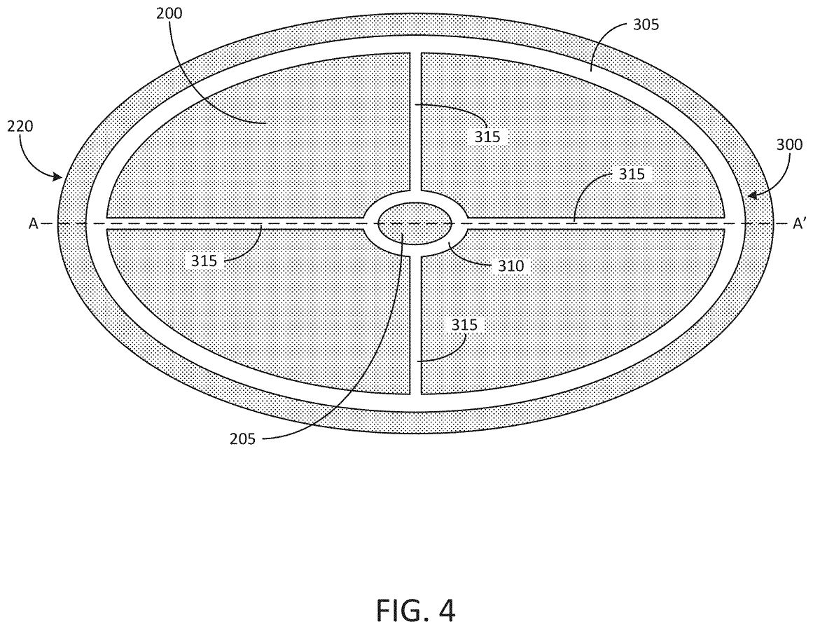

FIG. 4 depicts an example perspective view of a buckling plate 200 and wagon wheel 300 arranged together. The buckling plate 200 and the wagon wheel 300 can be arranged concentrically such that the domed portion 205 of the buckling plate 200 protrudes through the inner ring 310 of the wagon wheel 300. Thus, the dimensions of the domed portion 205 of the buckling plate 200 can be selected such that the perimeter edge 210 of the domed portion 205 of the buckling plate 200 has substantially (e.g., +/10%) the same diameter as the inner ring 310 of the wagon wheel 300. This diameter can be 7 millimeters. In some examples, this diameter can be in the range of 5 millimeters to 9 millimeters. The perimeter edge 220 of the buckling plate 200 may have a larger diameter than that of the outer ring 305 of the wagon wheel 300, as illustrated in FIG. 4. For example, this can allow a portion of the buckling plate 200 (e.g., the portion that extends beyond the diameter of the outer ring 305 of the wagon wheel 300) to be subjected to a crimping process, which is described in connection with FIG. 6. The diameter of the outer ring 305 of the wagon wheel 300 can be in the range of 15 millimeters to 21 millimeters. For example, the diameter of the outer ring 305 of the wagon wheel 300 can be 19 millimeters. In some examples, the outer ring 305 of the wagon wheel 300 and the perimeter edge 220 of the buckling plate 200 may have the same diameter. The width of the outer ring 305 of the wagon wheel 300 can be in the range of 1 millimeter to 5 millimeters.

The inner ring 310 of the wagon wheel 300 can be electrically coupled to the domed portion 205 of the buckling plate 200. For example, the inner ring 310 of the wagon wheel 300 can be spot welded to the domed portion 205 at or near the base of the domed portion 205 (e.g., at or near the perimeter edge 210 of the domed portion 205). The remaining portions of the wagon wheel 300 (i.e., the outer ring 305 and the spokes 315) can be electrically insulated from the buckling plate 200. For example, an insulating polymer layer can be positioned between the buckling plate 200 and the spokes 315 and the outer ring 305 of the wagon wheel 300, as described below in connection with FIG. 4. For example, in some examples the only point of electrical connection between the wagon wheel 300 and the buckling plate 200 can be at the interface of the inner ring 310 of the wagon wheel 300 and the domed portion 205 of the buckling plate 200, which may be at or near the perimeter edge 210 of the domed portion 205 of the buckling plate 200. Electrical connections can also be formed between the electrolyte material within the housing 105 and the outer ring 305 of the wagon wheel 300, and between the buckling plate 200 and the positive terminal 115 of the battery 100. Thus, a path for current within the battery 100 can be provided from the electrolyte material to the outer ring 305 of the wagon wheel 300, through the spokes 315 to the inner ring 310 of the wagon wheel 300, to the buckling plate 200, and finally to the positive terminal 115 of the battery 100.

When, for example, the domed portion 205 of the buckling plate 200 buckles away from the electrolyte material and towards the positive terminal 115 of the battery 100 (e.g., in response to a threshold pressure within the battery 100, as described above), the connection between the inner ring 310 of the wagon wheel 300 and the domed portion 205 of the buckling plate 200 can become severed. For example, the buckling of the domed portion 205 of the buckling plate 200 can break one or more spot welds that initially secure the domed portion 205 of the buckling plate 200 to the inner ring 310 of the wagon wheel 300. As described above, this area can be the only point of electrical connection between the buckling plate 200 and the wagon wheel 300. As a result, current may no longer pass through the positive terminal 115 of the battery 100 when the domed portion 205 of the buckling plate 200 buckles.

When the current in the battery 100 reaches a threshold condition, the spokes 315 can increase in temperature due to resistive heating. For example, the threshold current that triggers melting of the spokes 315 can be in the range of 50 A to 100 A. When one of the spokes 315 melts, the electrical load placed on each of the other spokes 315 can increase until all of the spokes 315 melt in a cascade, thereby serving as a fuse to interrupt current within the battery cell 100. Similarly, when the temperature within the battery cell 100 reaches a threshold level, the spokes 315 can melt, prohibiting current from passing through the positive terminal 115 of the battery 100. Thus, the buckling plate 200 and the wagon wheel 300 can together be configured to respond to any combination of a threshold pressure, a threshold temperature, or a threshold current by interrupting the flow of current in the battery cell 100.

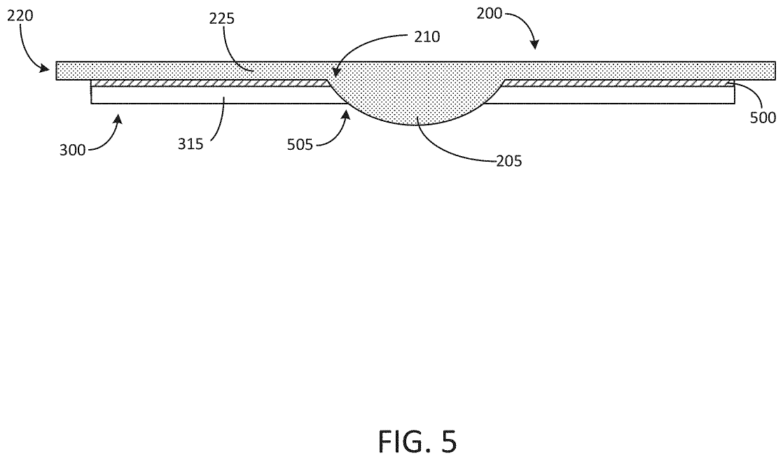

FIG. 5 depicts a cross-sectional view of an example buckling plate 200 and wagon wheel 300 arranged together, according to an illustrative implementation. The cross-sectional view depicted in FIG. 5 is taken along the line A-A′ shown in FIG. 4. As shown, at least a portion of the wagon wheel 300 may be electrically isolated from at least a portion of the buckling plate 200 by an insulating layer 500. The insulating layer 500 can be formed from any type of electrically insulating material, such as insulating polymer material. The insulating layer 500 can be positioned only between portions of the wagon wheel 300 that overlap with the planar portion 225 of the buckling plate 200, such as the outer ring 305 and the spokes 315 of the wagon wheel 300. In other examples, the insulating layer 500 can cover substantially all (e.g., >90%) of the planar portion 225 of the buckling plate 200.

Also as depicted in FIG. 5 among others, the only interface between the wagon wheel 300 and the buckling plate 200 can occur at the point labeled 505, which can be positioned at or near (e.g., within 3 millimeters of) the base or perimeter edge 210 of the domed portion 205 of the buckling plate 200. Thus, when the domed portion 205 of the buckling plate 200 buckles or deflects in response to a threshold pressure, this electrical connection can break and electrical current may no longer flow within the battery cell 100.

FIG. 6 depicts a cross-sectional view of a portion of a first example battery cell 100 for an electric vehicle battery pack including a buckling plate 200 and a wagon wheel 300. The buckling plate 200 and the wagon wheel 300 can be arranged in a manner similar to that shown in FIG. 4, and can be installed together beneath the positive terminal 115 in the head portion 130 of the battery 100. For illustrative clarity, some portions of the battery 100 are not visible in FIG. 6. As shown, the upper surface 120 and the lower surface 125 of the positive terminal 115 can be joined by a sidewall 600. The lower surface 125 of the positive terminal 115 can be supported by the buckling plate 200, and the perimeter edge 220 of the buckling plate 200 can wrap around the lower surface 125 of the positive terminal 115. In this example, the buckling plate 200 forms part of a seal that seals the electrolyte material 610 within the housing 105 and separates the electrolyte material 610 from the external environment. The electrolyte material 610 is positioned within the body portion 135 of the battery cell 100.

To achieve the wrapping of the perimeter edge 220 of the buckling plate 200 around the lower surface 125 of the positive terminal 115, the buckling plate 200 can be subjected to a crimping process in which the perimeter edge 220 of the buckling plate 200 is bent around the lower surface 125 of the positive terminal 115. The buckling plate 200 is oriented so that the domed portion 205 of the buckling plate 200 protrudes away from the positive terminal 115 towards the electrolyte material 610.

A gasket 605 surrounds the buckling plate 200 and can be crimped over the perimeter edge 220 of the buckling plate 200. The gasket 605 can electrically insulate the buckling plate 200 from other components of the battery cell 100, such as the housing 105. The gasket 605 also forms a portion of the seal that seals the electrolyte material 610 within the housing 105 and separates the electrolyte material 610 from the external environment. The housing 105 can also be crimped over the edge of the gasket 605, as depicted in FIG. 6, to define the lip 110 of the battery cell 100. The lip 110 may serve as a negative terminal of the battery cell 100. The buckling plate 200, the gasket 605, and the housing 105 can all be crimped together in a single crimping operation or can be crimped separately through separate crimping operations.

The outer ring 305 of the wagon wheel 300 can be electrically coupled with the electrolyte material 610 housed within the battery cell 100, for example by the conductive member 615. The conductive member 615 can be any type of member capable of forming an electrical connection between the outer ring 305 of the wagon wheel 300 and the electrolyte material 610. The conductive member 615 can be formed from a conductive metal, such as copper or steel. The conductive member 615 can also be formed from a conductive polymer or any other type of material capable of conducting electricity between the electrolyte material 610 and the outer ring 305 of the wagon wheel 300. The conductive member 615 can be a conductive wire or other element that is fixed to each of the electrolyte material 610 and the outer ring 305 of the wagon wheel 300, for example via one or more spot welds. Under normal operating conditions in which thermal runaway does not occur, current can flow from the electrolyte material 610 to the outer ring 305 of the wagon wheel 300, through the spokes 315 to the inner ring 310 of the wagon wheel 300, which can be electrically coupled with the edge of the domed portion 205 of the buckling plate 200. Thus, the buckling plate 200 can receive the current from the inner ring 310 of the wagon wheel 300, and the positive terminal 115 can receive the current from the buckling plate 115. When any combination of a threshold pressure, a threshold temperature, or a threshold current is experienced within the battery cell 100 (e.g., due to a thermal runaway event), the domed portion 205 of the buckling plate 200 can be configured or structured to tear, deform, deflect, or buckle away from the electrolyte material 610 and toward the positive terminal 115, thereby breaking the electrical connection between the buckling plate 200 and the wagon wheel 300, as described above. As a result, the flow of current can be stopped in the battery cell 100, which can help to slow or eliminate the process of thermal runaway that resulted in the threshold pressure, the threshold current, or the threshold temperature.

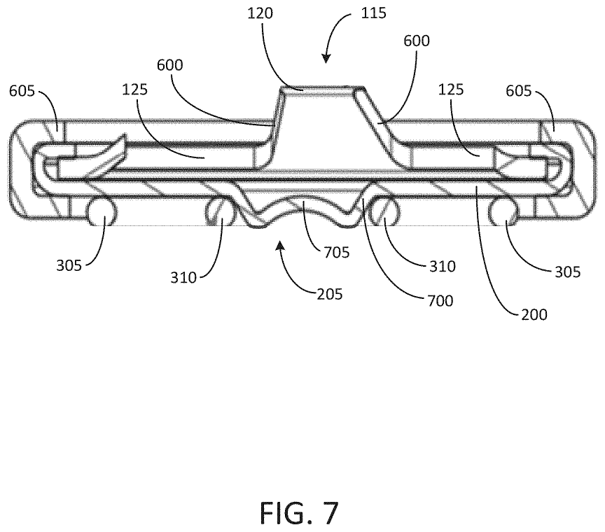

FIG. 7 depicts an example cross-sectional view of a portion of a second example battery cell 100 for an electric vehicle battery pack including a buckling plate 200 and a wagon wheel 300. For example, the domed portion 205 can include an outer curved portion 700 that protrudes away from the positive terminal 115 starting from the perimeter or base of the domed portion 205. A central curved portion 705 couples to the outer curved portion 700 and has a curvature opposed to the curvature of the outer curved portion 700. That is, the central curved portion 705 protrudes back toward the positive terminal 115. This shape can facilitate deflection of the domed portion 205 of the buckling plate 200 toward the positive terminal 115 in response to a pressure threshold being reached in the battery cell 100. Either the outer curved portion 700 or the central curved portion 705 (or both) may also include one or more scoring lines configured to cause the domed portion 205 to rupture when a pressure threshold has been reached. Other shapes for the domed portion 205 of the buckling plate 200 are possible. The domed portion 205 can be formed in any shape having at least a portion that protrudes away from the planar or substantially planar surface of the remainder of the buckling plate 200. For example, the domed portion 205 may include any number of walls which may have different degrees of curvature, and may include features such as corrugations, scoring lines, or any other type of feature configured to cause the buckling plate 200 to deform, deflect, tear, or rupture when subjected to a predetermined pressure threshold.

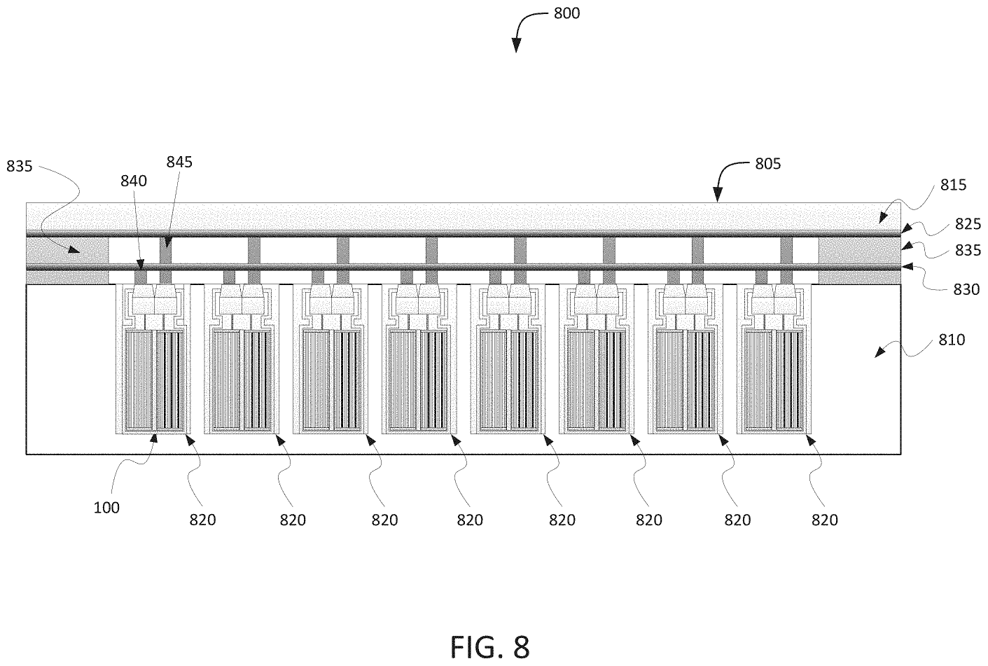

FIG. 8, depicts a cross-section view 800 of a battery pack 805 to hold a plurality of battery cells 100 in an electric vehicle. The battery pack 805 can include a battery module case 810 and a capping element 815. The battery module case 810 can be separated from the capping element 815. The battery module case 810 can include or define a plurality of holders 820. Each holder 820 can include a hollowing or a hollow portion defined by the battery module case 810. Each holder 820 can house, contain, store, or hold a battery cell 100. The battery module case 810 can include at least one electrically or thermally conductive material, or combinations thereof. The battery module case 810 can include one or more thermoelectric heat pumps. Each thermoelectric heat pump can be thermally coupled directly or indirectly to a battery cell 100 housed in the holder 820. Each thermoelectric heat pump can regulate temperature or heat radiating from the battery cell 100 housed in the holder 820. Bonding elements 850 and 855, which can each be electrically coupled with a respective one of the positive terminal 115 or a negative terminal (e.g., the lip 110 of the housing 105) of the battery cell 100, can extend from the battery cell 100 through the respective holder 820 of the battery module case 810.

Between the battery module case 810 and the capping element 815, the battery pack 805 can include a first busbar 825, a second busbar 830, and an electrically insulating layer 835. The first busbar 825 and the second busbar 830 can each include an electrically conductive material to provide electrical power to other electrical components in the electric vehicle. The first busbar 825 (sometimes referred to as a first current collector) can be connected or otherwise electrically coupled with the first bonding element 850 extending from each battery cell 100 housed in the plurality of holders 820 via a bonding element 845. The bonding element 845 can be bonded, welded, connected, attached, or otherwise electrically coupled with the bonding element 850. For example, the bonding element 845 can be welded onto a top surface of the bonding element 850. The second busbar 830 (sometimes referred to as a second current collector) can be connected or otherwise electrically coupled with the second bonding element 855 extending from each battery cell 100 housed in the plurality of holders 820 via a bonding element 840. The bonding element 840 can be bonded, welded, connected, attached, or otherwise electrically coupled with the second bonding element 855. For example, the bonding element 840 can be welded onto a top surface of the second bonding element 855. The second busbar 830 can define the second polarity terminal for the battery pack 805.

The first busbar 825 and the second busbar 830 can be separated from each other by the electrically insulating layer 835. The electrically insulating layer 835 can include spacing to pass or fit the first bonding element 850 connected to the first busbar 825 and the second bonding element 855 connected to the second busbar 830. The electrically insulating layer 835 can partially or fully span the volume defined by the battery module case 810 and the capping element 815. A top plane of the electrically insulating layer 835 can be in contact or be flush with a bottom plane of the capping element 815. A bottom plane of the electrically insulating layer 835 can be in contact or be flush with a top plane of the battery module case 810. The electrically insulating layer 835 can include any electrically insulating material or dielectric material, such as air, nitrogen, sulfur hexafluoride (SF₆), porcelain, glass, and plastic (e.g., polysiloxane), among others to separate the first busbar 825 from the second busbar 830.

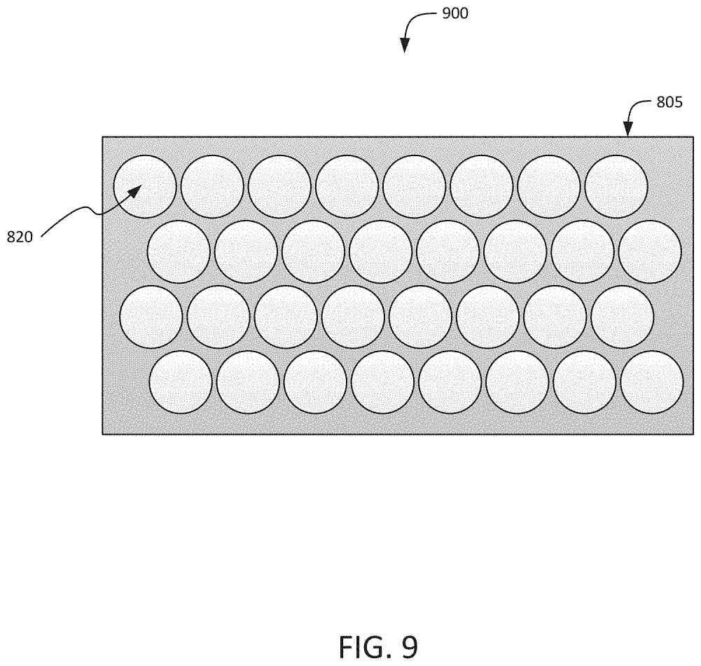

FIG. 9 depicts a top-down view 900 of a battery pack 805 to hold a plurality of battery cells 100 in an electric vehicle. The battery pack 805 can define or include a plurality of holders 820. The shape of each holder 820 can be triangular, rectangular, pentagonal, elliptical, and circular, among others. The shapes of each holder 820 can vary or can be uniform throughout the battery pack 805. For example, some holders 820 can be hexagonal in shape, whereas other holders can be circular in shape. The shape of the holder 820 can match the shape of a housing of each battery cell 100 contained therein. The dimensions of each holder 820 can be larger than the dimensions of the battery cell 100 housed therein.

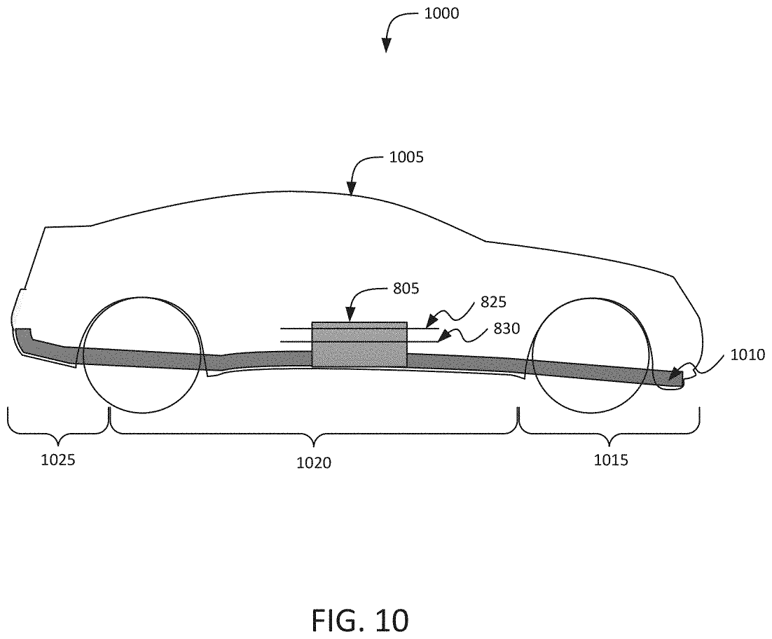

FIG. 10 depicts a cross-section view 1000 of an electric vehicle 1005 installed with a battery pack 805. The electric vehicle 1005 can include a chassis 1010 (sometimes referred to as a frame, internal frame, or support structure). The chassis 1010 can support various components of the electric vehicle 1005. The chassis 1010 can span a front portion 1015 (sometimes referred to a hood or bonnet portion), a body portion 1020, and a rear portion 1025 (sometimes referred to as a trunk portion) of the electric vehicle 1005. The battery pack 805 can be installed or placed within the electric vehicle 1005. The battery pack 805 can be installed on the chassis 1010 of the electric vehicle 1005 within the front portion 1015, the body portion 1020 (as depicted in FIG. 10), or the rear portion 1025. The first busbar 825 and the second busbar 830 can be connected or otherwise be electrically coupled with other electrical components of the electric vehicle 1005 to provide electrical power. The battery cells 100 referred to above in connection with FIGS. 8-10 may each include a buckling plate 200 and a wagon wheel 300 in order to respond to any combination of a threshold pressure, a threshold temperature, and a threshold current in the manner described above.

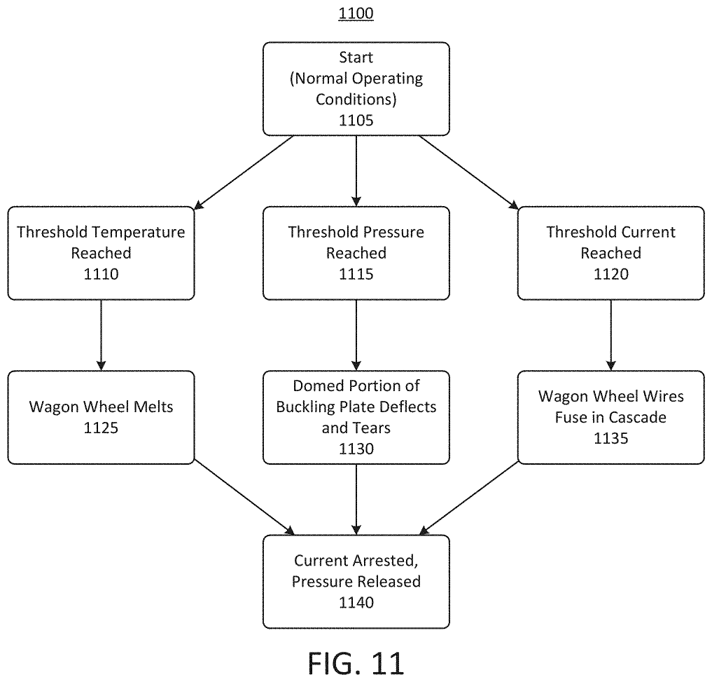

Referring now to FIG. 11 among others, together the buckling plate 200 and the wagon wheel 300 can respond to threshold conditions of pressure, temperature, and current, each of which may be indicative of an imminent thermal runaway condition for the battery cell 100. FIG. 11 depicts a flow chart of an example process 1100 undergone by a battery experiencing various conditions associated with thermal runaway. The process 1100 begins at block 1105, in which the battery cell 100 is operating under normal conditions. In the event of a threshold temperature being reached within the battery cell 100, the process 1100 can proceed to block 1110. The threshold temperature can be any temperature known to indicate the onset of a thermal runaway event for the battery cell 100. The process 1100 can proceed to block 1125, in which the wagon wheel 300 melts in response to the threshold temperature being reached. For example, the wagon wheel 300 can be formed from a material having a melting point that corresponds to the threshold temperature reached in block 1110, such as a low melting point alloy. Because the wagon wheel 300 forms part of the current path from the electrolyte material 610 to the positive terminal 115 of the battery cell 100, melting of the wagon wheel 300 interrupts the current path and arrests this current, as indicated in block 1140 of the process 1100.

Referring again to block 1105, when a threshold pressure is reached in the battery cell 100, the process 1100 proceeds to block 1115. The threshold pressure can be any pressure that indicates the onset of a thermal runaway event for the battery cell 100. The process 1100 can proceed to block 1130, in which the domed portion 205 of the buckling plate 200 deflects upward toward the positive terminal 115 of the battery cell 100. This deflection can break the electrical connection between the inner ring 310 of the wagon wheel 300, which may initially be formed by a spot welding bond. As a result, the current path in the battery cell 100 can be broken. If a second pressure threshold, greater than the threshold at which the domed portion 205 buckles, is reached, the second pressure threshold can also cause the domed portion 205 of the buckling plate 200 to tear or rupture, thereby providing an escape path for gases that may build up due to a thermal runaway event. The domed portion 205 of the buckling plate 200 can include scoring lines 215 to facilitate the tearing or rupturing of the domed portion 205 in response to the second threshold pressure. Thus, the current can be interrupted and the pressure can be released, as indicated in block 1140 of the process 1100.

Referring to block 1105, when a threshold current is reached in the battery cell 100, the process 1100 can proceed to block 1120. The threshold current can be any current that indicates the onset of a thermal runaway event for the battery cell 100. The process 1100 can proceed to block 1135, in which the spokes 315 of the wagon wheel 300 fuse in a cascaded manner. For example, the high current can heat the spokes 315 rapidly, eventually exceeding their melting temperature. As discussed above, each spoke 315 serves as part of the current path through the battery cell 100. Thus, when a first one of the spokes 315 melts and is no longer able to carry current, the current load on the remaining spokes 315 increases proportionally, causing them to heat further. The spokes 315 can therefore melt in succession, serving as a fuse to interrupt the current path through the battery cell 100 after the last spoke 315 has melted. As a result, the current can be interrupted, as indicated in block 1140 of the process 1100.

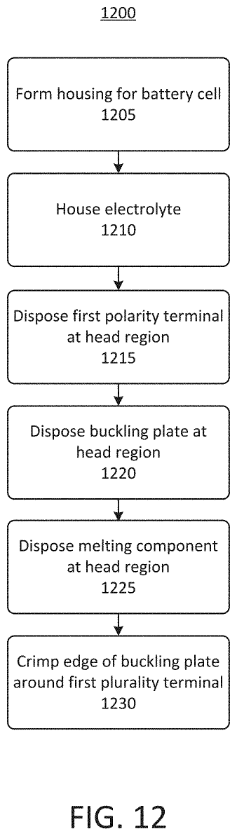

FIG. 12 depicts a flow chart of an example process 1200 of providing a battery cell for a battery pack of an electric vehicle, according to an illustrative implementation. The battery cell can correspond to the battery cell 100. The process 1200 can include forming a housing 105 for the battery cell 100 of a battery pack having a plurality of battery cells (block 1205). The housing can have a body region 135 and a head region 130. The head region 130 can be disposed at a lateral end of the battery cell 100. The housing can be formed, for example, from a structurally rigid material, such as steel. The housing can be formed from a conductive material. For example, forming the housing from a conductive material can allow at least a portion of the housing to serve as a terminal of the battery cell 100.

The process 1200 can include housing, within the body region 135 of the battery cell 100, an electrolyte material 610 (block 1210). The electrolyte material 610 can include at least one charged portion configured to provide electric power for the battery cell 100. In some examples, at least a portion of the electrolyte material 610 may be electrically isolated from the housing 105.

The process 1200 can include disposing, at the head region 130 of the housing 105, a first polarity terminal 115 (block 1215). The first polarity terminal 115 can be either a positive terminal or a negative terminal. The first polarity terminal 115 can be formed from a conductive material, such as steel or copper, and can include a “table top” surface that serves as a portion of a cap of the battery cell 100.

The process 1200 can include disposing, at the head region 130 of the housing 105, a buckling plate 200 having a planar portion 225 and a domed portion 205 (block 1220). The domed portion 205 can have a convex part extending toward the electrolyte material 610. The domed portion 205 can deflect away from the electrolyte material 610 in response to a first predetermined threshold pressure within the battery cell 100. For example, the domed portion 205 can be configured to deform or buckle at a threshold pressure, based on its physical characteristics including material strength and shape. In some examples, the domed portion 205 can include features such as scoring lines 215 to facilitate rupturing of the domed portion 205 in response to a second predetermined threshold pressure, greater than the first predetermined threshold pressure.

The process 1200 can include disposing, at the head region 130 of the housing 105, a melting component to electrically couple an inner ring of the melting component to the domed portion 205 of the buckling plate 200 and to electrically couple an outer ring of the melting component to the electrolyte material 610 (block 1225). The melting component can be a wagon wheel 300 that has a plurality of spokes 315 coupling the inner ring 310 with the outer ring 305, as depicted in FIG. 3, among others. The plurality of spokes 315 can be configured to melt in response to either a predetermined threshold temperature or a predetermined threshold current within the battery cell 100. For example, the plurality of spokes 315 can be formed from a low melting point material such as bismuth or lead. The material can be selected to have a melting point at or near the predetermined threshold temperature. In some examples, an insulating layer can be positioned to electrically isolate the spokes 315 and the outer ring 305 of the wagon wheel 300 from the buckling plate 200. The inner ring 310 of the wagon wheel 300 can be electrically coupled to the base or perimeter edge 210 of the domed portion 205 of the buckling plate 200, for example via one or more spot welds. The outer ring 305 of the wagon wheel 300 can be electrically coupled to the electrolyte material 610 by a conductive member 615.

The process 1200 can include crimping a perimeter edge 220 of the buckling plate 200 around the first polarity terminal 115 to electrically couple the buckling plate 200 to the first polarity terminal 115 (block 1230). After the crimping, the buckling plate 200 may serve as at least a portion of a seal that seals the electrolyte material 610 within the housing 105 and separates the electrolyte material 610 from the outside environment. Crimping the perimeter edge 220 of the buckling plate 200 can also include crimping a gasket 605 or a perimeter edge of the housing 105, or both, around the first polarity terminal 115. For example, crimping the perimeter edge of the housing 105 can result in a lip 110 formed by the perimeter edge of the housing, which may serve as a second polarity terminal.

According to the process 1100, the buckling plate 200 and the wagon wheel 300 can respond to any combination of a threshold temperature, and threshold pressure, and a threshold current occurring within the battery cell 100 by arresting the current and releasing the pressure. This represents an advancement relative to battery protection devices. For example, battery protection devices may include thermal protection in the form of a thermistor having a positive temperature coefficient (PTC) embedded in a battery protection device, such as a cap. However, when such a thermistor activates, the resistivity of the thermistor is permanently increased. As a result, resistive heating increases in the cap, increasing the likelihood of catastrophic failure in the future. In contrast, the low melting point wagon wheel 300 described in this disclosure provides a response to temperature changes that is both reliable and permanent. Battery caps can respond to pressure using a CID. However, high temperature can precede the generation of enough gas to trigger the CID or vents. Thus, absent the improvements described herein, a battery cell may be unable to respond adequately to all three stimuli (i.e., pressure, temperature, and current) that coincide with thermal runaway events.

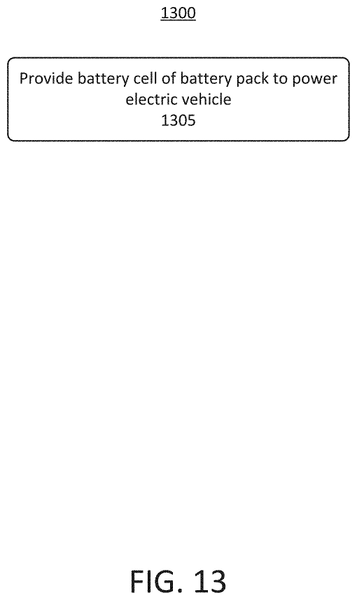

FIG. 13 depicts a flow chart of an example process 1300 of providing a battery cell for a battery pack of an electric vehicle, according to an illustrative implementation. The battery cell can correspond to the battery cell 100. The process 1300 can include providing a battery cell 100 of a battery pack 805 to power an electric vehicle 1005 (block 1305). The battery cell 100 can include a housing 105 containing an electrolyte material 610, and a first polarity terminal 115 disposed at a lateral end of the battery cell 105. The battery cell 105 can include a buckling plate 200 disposed at the lateral end of the battery cell and electrically connected with the first polarity terminal 115. The buckling plate 200 can include a planar portion 225 and a domed portion 205. The domed portion 205 can have a convex part extending toward the electrolyte material 610. The domed portion 205 can be structured to deflect away from the electrolyte material 610 in response to a first predetermined threshold pressure within the battery cell 100. The battery cell 100 can include a melting component 300. The melting component 300 can have an inner ring 310 surrounding and electrically coupled with a base or perimeter edge 210 of the domed portion 205 of the buckling plate 200, an outer ring 305 surrounding the inner ring 310 and electrically coupled with the electrolyte material 610, and a plurality of spokes 315 coupling the inner ring 310 with the outer ring 305. The plurality of spokes 315 can melt in response to at least one of a predetermined threshold temperature and a predetermined threshold current within the battery cell 100.

Having now described some illustrative implementations, it is apparent that the foregoing is illustrative and not limiting, having been presented by way of example. Features that are described herein in the context of separate implementations can also be implemented in combination in a single embodiment or implementation. Features that are described in the context of a single implementation can also be implemented in multiple implementations separately or in various sub-combinations. References to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any act or element may include implementations where the act or element is based at least in part on any act or element.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included for the sole purpose of increasing the intelligibility of the drawings, detailed description, and claims. Accordingly, neither the reference signs nor their absence have any limiting effect on the scope of any claim elements.

The systems and methods described herein may be embodied in other specific forms without departing from the characteristics thereof. For example, descriptions of positive and negative electrical characteristics may be reversed. For example, elements described as negative elements can instead be configured as positive elements and elements described as positive elements can instead by configured as negative elements. Further relative parallel, perpendicular, vertical or other positioning or orientation descriptions include variations within +/−10% or +/−10 degrees of pure vertical, parallel or perpendicular positioning. References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

1. A battery cell of a battery pack to power an electric vehicle, comprising:
a housing containing an electrolyte material;
a first polarity terminal disposed at a lateral end of the battery cell;
a buckling plate disposed at the lateral end of the battery cell and electrically connected with the first polarity terminal, the buckling plate comprising a planar portion and a domed portion, the domed portion having a convex part extending toward the electrolyte material, the domed portion structured to deflect away from the electrolyte material in response to a first predetermined threshold pressure within the battery cell; and
a melting component comprising:
an inner ring surrounding and electrically coupled with a perimeter of the domed portion of the buckling plate;
an outer ring surrounding the inner ring and electrically coupled with the electrolyte material, and;
a plurality of spokes coupling the inner ring with the outer ring, the plurality of spokes to melt in response to at least one of a predetermined threshold temperature and a predetermined threshold current within the battery cell.

2. The battery cell of claim 1, comprising:
an insulating layer disposed between at least a portion of the melting component and at least a portion of the buckling plate to electrically insulate the plurality of spokes and the outer ring of the melting component from the buckling plate.

3. The battery cell of claim 2, comprising:
the insulating layer including a polymer material.

4. The battery cell of claim 1, comprising
the domed portion of the buckling plate having at least one scoring line to cause the domed portion of the buckling plate to rupture in response to a second predetermined threshold pressure within the battery cell, the second predetermined threshold pressure greater than the first predetermined threshold pressure.

5. The battery cell of claim 1, comprising:
the inner ring of the melting component spot welded to a perimeter edge of the domed portion of the buckling plate.

6. The battery cell of claim 1, comprising:
an edge of the buckling plate crimped around a portion of the first polarity terminal.

7. The battery cell of claim 1, comprising:
a gasket formed from an electrically insulating material to seal the electrolyte material within the housing of the battery cell.

8. The battery cell of claim 1, comprising:
a gasket formed from an electrically insulating material to seal the electrolyte material within the housing of the battery cell, wherein an edge of the buckling plate and an edge of the first terminal are crimped around a portion of the gasket.

9. The battery cell of claim 1, comprising:
the melting component comprising at least one of bismuth and lead.

10. The battery cell of claim 1, wherein:
the predetermined threshold temperature is between 120 degrees C. and 140 degrees C.

11. The battery cell of claim 1, comprising:
at least one of the predetermined threshold current between 50 A and 100 A and the first predetermined threshold pressure is between 60 PSI and 500 PSI.

12. The battery cell of claim 1, comprising:
the outer ring of the melting component having a diameter between 15 millimeters and 21 millimeters.

13. The battery cell of claim 1, comprising:
the outer ring of the melting component having a width between 1 millimeter and 5 millimeters.

14. The battery cell of claim 1, comprising:
the domed portion of the buckling plate having a thickness between 0.5 millimeters and 0.7 millimeters.

15. The battery cell of claim 1, comprising:
the domed portion of the buckling plate having a diameter between 5 millimeters and 9 millimeters; and
the inner ring of the melting component having a diameter equal to the diameter of the domed portion of the buckling plate.

16. The battery cell of claim 1, comprising:
the buckling plate having a diameter between 19 millimeters and 23 millimeters.

17. The battery cell of claim 1, wherein:
the battery cell is part of a battery pack that includes a plurality of additional battery cells.

18. The battery cell of claim 1, wherein:
the battery cell is part of a battery pack that includes a plurality of additional battery cells disposed in an electric vehicle.

19. A method, comprising:
providing a battery cell of a battery pack to power an electric vehicle, the battery cell comprising:
a housing containing an electrolyte material;
a first polarity terminal disposed at a lateral end of the battery cell;
a buckling plate disposed at the lateral end of the battery cell and electrically connected with the first polarity terminal, the buckling plate comprising a planar portion and a domed portion, the domed portion having a convex part extending toward the electrolyte material, the domed portion structured to deflect away from the electrolyte material in response to a first predetermined threshold pressure within the battery cell; and
a melting component comprising:
an inner ring surrounding and electrically coupled with a perimeter of the domed portion of the buckling plate;
an outer ring surrounding the inner ring and electrically coupled with the electrolyte material, and;
a plurality of spokes coupling the inner ring with the outer ring, the plurality of spokes to melt in response to at least one of a predetermined threshold temperature and a predetermined threshold current within the battery cell.

20. A method of providing battery cells for battery packs of electric vehicles, comprising:
forming a housing for a battery cell of a battery pack having a plurality of battery cells, the housing having a body region and a head region disposed at a lateral end of the battery cell;
housing, within the body region of the battery cell, an electrolyte material;
disposing, at the head region of the housing, a first polarity terminal;
disposing, at the head region of the housing, a buckling plate having a planar portion and a domed portion, the domed portion having a convex part extending the electrolyte material, the domed portion configured to deflect away from the electrolyte material in response to a first predetermined threshold pressure within the battery cell;
disposing, at the head region of the housing, a melting component to electrically couple an inner ring of the melting component to the domed portion of the buckling plate and to electrically couple an outer ring of the melting component to the electrolyte material, the melting component having a plurality of spokes coupling the inner ring with the outer ring, the plurality of spokes configured to melt in response to either a predetermined threshold temperature or a predetermined threshold current within the battery cell; and
crimping a perimeter edge of the buckling plate around the first polarity terminal to electrically couple the buckling plate to the first polarity terminal.
